(19) United States
(12) Patent Application Publication
(10) Pub. No.: US 2011/0041561 A1
(43) Pub. Date: Feb. 24, 2011

(54) Apparatus And Method For Supplying Hot, Cold Or Mixed Water To A Washing Machine Using A Single Water Supply Hose

(76) Inventor: Adam Apel, Boca Raton, FL (US)

Correspondence Address: JOHN C. SMITH, P.A., 4125 NW 58th LANE, BOCA RATON, FL, 33496, US

(21) Appl. No.: 12/859,762

(22) Filed: Aug. 19, 2010

Related U.S. Application Data
(60) Provisional application No. 61/236,119, filed on Aug. 23, 2009.

(51) Int. Cl. D06F 33/00; F16K 51/00; G05D 23/13; F17D 3/01

(52) U.S. Cl. 68/12.02; 137/215; 236/12.12; 137/3

(57) ABSTRACT

A washing machine with a single input hose for both hot and cold water. The solenoid-operated water mixing valve assembly has a direct attachment to the hot and cold water supply valves. A flexible hose connects the washing machine to the solenoid-operated water mixing valve assembly. When the washing machine fill cycle begins, the solenoid-operated water mixing valve assembly is turned on and the water is output to the flexible hose. When the washing machine fill cycle ends, the water supply is turned off. The hot and cold water are mixed prior to input to the flexible hose, and as a result, only one flexible hose is required to supply water to the washing machine. The flexible hose is attached to the output of the solenoid-operated water mixing valve assembly and therefore is not under water pressure unless the washing machine is in a fill cycle. A vacuum breaker can be attached to the output of the solenoid-operated water mixing valve assembly to prevent backflow into the building water supply from the hose connection.

### CROSS-REFERENCE TO RELATED APPLICATIONS

This application is related to, and claims the benefit of, the co-pending provisional patent application entitled “Apparatus And Method For Supplying Hot, Cold Or Mixed Water To A Washing Machine Using A Single Water Supply Hose”, filed Aug. 23, 2009, bearing U.S. Ser. No. 61/236,119 and naming Adam Apel, the named inventor herein, as sole inventor, the contents of which is specifically incorporated by reference herein in its entirety.

### BACKGROUND OF THE INVENTION

1. Technical Field

The present invention relates to washing machines, including clothes washing machines or other devices that periodically obtain hot and cold water from separate water supplies via flexible hoses. In particular, it relates to a reduced component washing machine system that has a single water supply line that is only under water pressure when the washing machine turns on water flow. An in-line thermostatically controlled water heater provides heated water on demand.

2. Background Art

The use of washing machines in homes and business establishments has provided users with convenience as well as an inexpensive way to clean items. Washing machines have been developed for clothes washing and are installed in most dwellings. For ease of discussion, the term washing machine will be used herein to discuss both clothes washers and any other device that may periodically obtain hot and/or cold water via separate flexible hoses. Typically, washing machines use both cold and hot water. As a result, two supply lines are attached to the water input of the washing machines, one for cold water, and the other for a separate hot water line. The water supply lines are typically flexible hoses that connect on one end to the water input of the washing machine and on the other end to a water shutoff valve attached to a wall.

A drawback to conventional designs is that the flexible hoses used to supply water to washing machines are directly attached to the building's water supply. As a result, these flexible hoses are always under water pressure from the building's water supply. This constant pressure is a significant problem since it contributes to early failure of the flexible hosing. When the flexible hosing fails, the user's facility will rapidly flood if the user does not turn off the water supply. In the event the user is available, and quickly shuts off the water supply, the damage may be limited. However, in the event the user is not on the premises, the rapid discharge of water may result in substantial damage to the user's facility, perhaps even resulting in structural damage to the building. Further, when the user's facility is one floor of a multi-floor dwelling or commercial building, their neighbors may also be flooded. It would be desirable to limit the pressure on water supply hoses to avoid early failure caused by the effects of constant water pressure on the flexible water supply hoses used by washing machines.

An additional factor that increases the risk of hose failure is that the cold water and the hot water used by a washing machine is input to the washing machine via separate supply lines. As a result, each washing machine has two flexible hoses under constant pressure, each of which may fail, resulting in damage to the user's facility. It would be desirable to have a single flexible hose supplying water to the washing machine rather than the two flexible hoses used by the prior art to further reduce the risk of hose failure by limiting the number of hoses.

The prior art has attempted to reduce water damage caused by failure of flexible water supply hoses when washing machines are not in use. One known device is a wall-mounted system that turns off the water supply to the water supply hoses when it senses that the washing machine is off. This system adds an extra set of solenoid controlled shutoff valves between a conventional washing machine and the manual shutoff valves attached to the wall. The washing machine power plug is plugged into the wall-mounted unit. A current sensor in the wall mounted unit senses when the washing machine is turned on and opens the solenoid-operated valve to allow water to flow into the flexible water supply hose from the building water supply. When the current sensor determines that the washing machine is turned off, the solenoid valves are closed to isolate the water supply to the flexible water supply hoses.

While this system limits the amount of water damage that will occur due to a flexible hoses failure, it has several disadvantages. One disadvantage is that it requires the use of additional components, heretofore not used by conventional washing machines. For example, the additional components include the current sensor circuitry, the additional solenoids, and their associated parts. This results in greater expense to the user when purchasing the components used by this system, as well as the possibility that additional repair expenses may be incurred in the event that one of these new components fails.

Another disadvantage is that it still requires the use of three hoses: two flexible water supply hoses and a third fill hose. Since the number of hoses used with this system is the same as that used with conventional systems, no additional benefit is provided by this system over the other prior art in this regard.

An additional disadvantage associated with this system is that the wall mounted solenoid operated valves are opened whenever current is sensed. This means that water pressure is applied to the water hoses during the entire washing machines usage, not just during the fill cycle of the washing machine. Further, the current sensors only know when current is present, they do not know why the current is present. Therefore, if a user plugs another device into the outlet intended for the washing machine (for example, a lamp), or if the user plugs a power strip or other device used to increase the number of outlets, then any time that any of the outlets are used, the system will think that the washing machine is being used and will apply water pressure to the flexible hoses. If an additional device is plugged into the outlet in this manner, then depending on how the additional device is being used, it is possible that water pressure will remain on all of the time, thereby defeating the purpose of the system entirely. In addition, since the solenoids in this system are activated whenever current is sensed, they will also increase costs by using additional unneeded electricity when the washing machine is not being filled.

Yet another drawback to this system is that when current is no longer sensed, the system will shut off the solenoid-operated valves in the wall. The water in the flexible hoses will then be trapped under pressure between the wall mounted solenoid-operated valves and the solenoid-operated valves in the conventional washing machine. As a result, the flexible hoses remain under high pressure which contributes to hose fatigue and early failure.

Another disadvantage of the prior art is that no effective method of preventing water “backflow” (back-siphonage) has been provided when using washing machines with flexible hoses. In most communities, building plumbing codes require that the potable water supply system be protected against actual or potential backflow. Typically, plumbing codes require that water outlets with hose thread, under non-continuous pressure, shall be protected with a permanent non-removable atmospheric vacuum breaker. The atmospheric breakers are installed on the discharge side of the last control valve. Typically no shutoff valves are installed after the atmospheric breaker.

In a conventional washing machine, the solenoid-operated water mixing valve assembly acts as a downstream control valve. As a result, washing machines do not comply with the plumbing code standards required of all other devices attached to the water supply system in a building. It would be desirable to have a washing machine that complies with plumbing code backflow standards imposed on other devices.

Another problem associated with the prior art is the cost of maintaining a supply of hot water at all times so that hot water would be available when needed. This is a substantial waste of energy sense the water and the typical water tank will be kept warm for extended periods of time when not needed. It would be desirable that a clothes washing system which only uses energy to heat water when needed.

Yet another problem associated with prior art is that extensive plumbing is required to deliver water to a washing machine. Typically, to complete lines of water pipes must be run through dwelling or commercial building to provide both hot and cold water to the washing machine. This is substantial cost during construction, and doubles the risk of leaks over time. It would be desirable to have a system that only requires a single water pipe to deliver both hot and/or cold water.

The prior art has failed to provide a system that reduces the total number of required components and reduces the number of flexible supply hoses, while simultaneously reducing hose fatigue by eliminating water pressure on supply hoses whenever the washing machines are not being filled. It has also failed to provide a system in which only a single type is needed to deliver water to a close washer that requires both hot and cold water to operate. Further, the prior art has failed to provide a method of controlling backflow that complies with plumbing code standards.

### SUMMARY OF THE INVENTION

The present invention solves the foregoing problems with a first embodiment which removes the solenoid operated water mixing valve assembly from the washing machine and locates it on the wall with a direct attachment to the hot and cold water supply from the wall. The electronic controls in the washer are connected to the solenoid-operated water mixing valve assembly via a wiring cable. A single flexible water fill hose connects the washing machine to the solenoid-operated water mixing valve assembly. When the washing machine fill cycle begins, the washing machine signals the solenoid-operated water mixing valve assembly and the water supply to the flexible water supply hose is turned on. When the washing machine fill cycle ends, the washing machine signals the solenoid operated water mixing valve assembly and the water supply to the flexible water supply hose is turned off. The hot and cold water are mixed prior to being input to the flexible fill hose, and as a result, only one flexible hose is required to supply the washing machine. The flexible hose is attached to the output of the solenoid-operated water mixing valve assembly and therefore is not under water pressure unless the washing machine is in a fill cycle.

The second embodiment provides a system in which the water supply is provided by a single line of cold water that inputs water to a wall mounted water heater that dynamically heats water under thermostatic control on an on-demand basis. This embodiment only requires a single water feed line. As a result, construction costs for providing water to a clothes washer are substantially reduced. The second element of this embodiment is the use of an in-line water heater. The in-line water heater reduces operating costs by only requiring water heating during operation and the clothes washer.

A third embodiment provides a system in which a cold water line provides water to the in-line water heater, and also bypasses the in-line water heater. The system then provides water to the clothes washer in the same manner as that used by the first embodiment.

A fourth embodiment provides the system similar to the second embodiment, except that the in-line water heater is internally mounted and the clothes washer. As a result, only a single cold water line need be attached to the clothes washer.

### BRIEF DESCRIPTION OF THE DRAWINGS

FIG. 1 is a perspective view of a prior art washing machine, showing the connection of two flexible water supply hoses to the rear of the machine.

FIG. 2 is a plan view of a prior art washing machine, showing the connection of two flexible water supply hoses to the rear of the machine, the location of the solenoid operated water mixing valve assembly, and the electronic controls.

FIG. 3 is a perspective view of a prior art water control device, used with a conventional washing machine, showing the connection of two flexible water supply hoses to the rear of the machine. This device uses an additional set of solenoids controlled by a current sensor to control water flow.

FIG. 4 is a plan view of a prior art water control device, used with a conventional washing machine, showing the connection of two flexible water supply hoses to the rear of the machine, the location of the solenoid operated water mixing valve assembly, the location of the electronic controls, and the location of the water control device.

FIG. 5 is a perspective view of a preferred embodiment showing the single flexible water supply hose, the electronic controls, the wiring cable, and the wall mounted location of the solenoid operated water mixing valve assembly.

FIG. 6 is a plan view of a preferred embodiment showing the single flexible water supply hose, the electronic controls, the wiring cable, and the wall mounted location of the solenoid operated water mixing valve assembly.

FIG. 7 is a plan view of a preferred embodiment showing a vacuum breaker backflow connector attached to the output of the wall mounted solenoid operated water mixing valve assembly.

FIG. 8 is a plan view of an alternative preferred embodiment in which a single cold water feed line inputs water to a wall mounted water heater that dynamically heats water under thermostatic control on an on-demand basis.

FIG. 9 is a plan view of another alternative preferred embodiment in which a water feed line inputs cold water to the in-line water heater, and also bypasses the in-line water heater with a shunt line. The system then provides water to the clothes washer in the same manner as that used by the first embodiment.

FIG. 10 is a plan view of yet another preferred embodiment in which a single cold feed line inputs water to a water heater that is wirelessly controlled on an on-demand basis.

FIG. 11 is another preferred embodiment in which solenoid valves are placed between the hot and cold water supplies a flow of mixed hot and cold water that has a selected temperature. The water is output to a washing machine via a single fill hose.

FIG. 12 is yet another preferred embodiment in which a single cold water supply feeds cold water to a cold water solenoid valve, and feeds cold water to a tankless water heater that in turn feeds hot water to a hot water solenoid valve. The hot and cold water is output to a washing machine via a single fill hose.

FIG. 13 is another preferred embodiment in which a single cold water supply feeds cold water to an adjustable temperature cold tankless water heater that in turn feeds water to a water solenoid valve. The water is output to a washing machine via a single fill hose.

### DESCRIPTION OF THE PREFERRED EMBODIMENT

Prior to discussing the figures, a general discussion of the features and advantages of the invention is presented. In the prior art, two separate flexible hoses supply hot and cold water under building pressure to a washing machine. The hoses are attached to the input of a solenoid-operated water mixing valve. The output of the solenoid operated water mixing valve is attached to a third hose that fills the machine with water. This arrangement requires three water hoses, of which two are under constant pressure. The constant pressure contributes to hose failure and the consequent water damage. This configuration also increases costs since more parts are used than are actually necessary.

The instant invention solves the foregoing problems by providing a washing machine that only needs a single hose. The hose is only under pressure when the washing machine is actually being filled. This is accomplished by removing the solenoid operated water mixing valve and attaching it to the water outlets at the wall. The solenoid-operated water mixing valve is directly attached to the pipes, thereby eliminating the flexible hoses on the input side. The fill hose that is attached to the output of the solenoid operated water mixing valve in a conventional washing machine is lengthened and remains attached to the output of the solenoid operated water mixing valve as before. The fill hose is only under pressure when the washing machine is actually being filled. As a result, hose failure is improbable at other times. Even if a hose fails during the filling process, the user is typically present at that time and can shut off the water supply to minimize damage. In addition, the electrical control wires in the washing machine are lengthened and attached to the solenoid-operated water mixing valve as before.

Another embodiment of the invention provides a system in which the water supply is a single line of cold water that inputs water to a wall mounted water heater. The heats water dynamically heats water under thermostatic control on an on-demand basis. This embodiment only requires a single water feed line. As a result, construction costs for providing water to a clothes washer are substantially reduced since twin hot and cold water lines are no longer needed. The second element of this embodiment is the use of an in-line water heater. The in-line water heater reduces operating costs by only requiring water heating during operation and the clothes washer.

A third embodiment provides a system in which a cold water line provides water to the in-line water heater, and also bypasses the in-line water heater. The system then provides hot and cold water lines to the clothes washer in the same manner as that used by the conventional clothes washers.

A fourth embodiment provides the system similar to the second embodiment, except that the in-line water heater is internally mounted and the clothes washer. As a result, only a single cold water line need be attached to the clothes washer.

Advantages provided by the invention include reduced construction cost or elimination of unnecessary water pipelines, reduced operating costs by only requiring order to be heated when needed, reduced risk of leakage by eliminating water pressure in the flexible hose when the clothes washer is not being used, and further reduced risk of leakage by requiring only a single flexible hose.

Having discussed the invention in general, we turn now to a detailed discussion of the drawings.

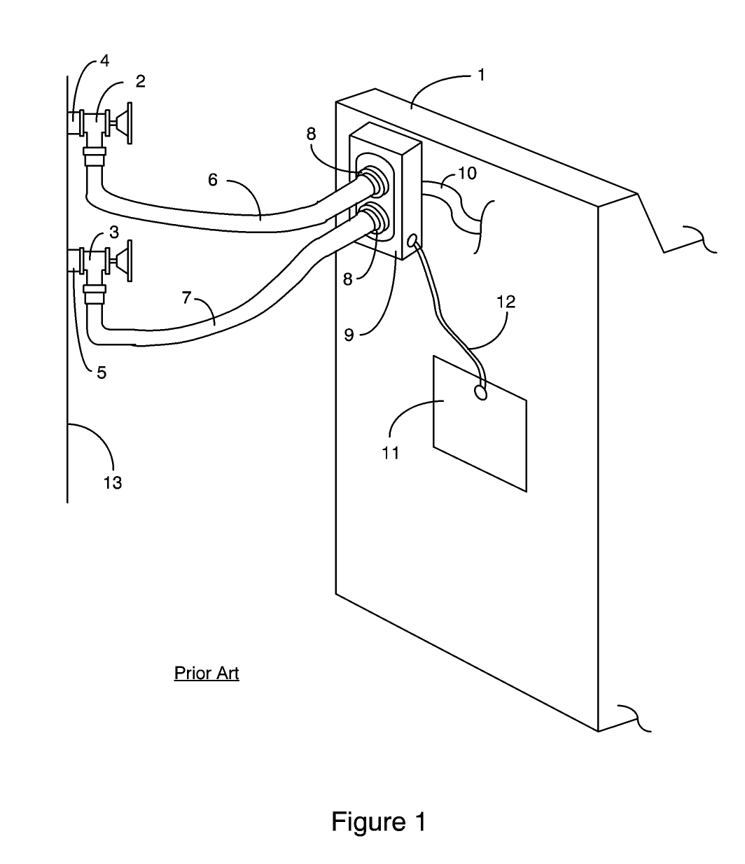

Referring to FIG. 1, this figure illustrates the prior art method of attaching a conventional washing machine 1 to a hot water supply 4 and a cold water supply 5 located at the building wall 13. For ease of illustration, some items in this figure are shown in dashed lines to indicate that they are inside the washing machine 1.

The hot water supply 4 and the cold water supply 5 are controlled by manual valves 2 and 3 respectively. The output of manual valve 2 is attached to a first flexible water supply hose 6 which is in turn attached to a first water input fitting 8 on the solenoid operated water mixing valve assembly 9 in washing machine 1 and the output of manual valve 3 is attached to a second flexible water supply hose 7 which is in turn attached to a second water input fitting 8 on the solenoid operated water mixing valve assembly 9 in washing machine 1.

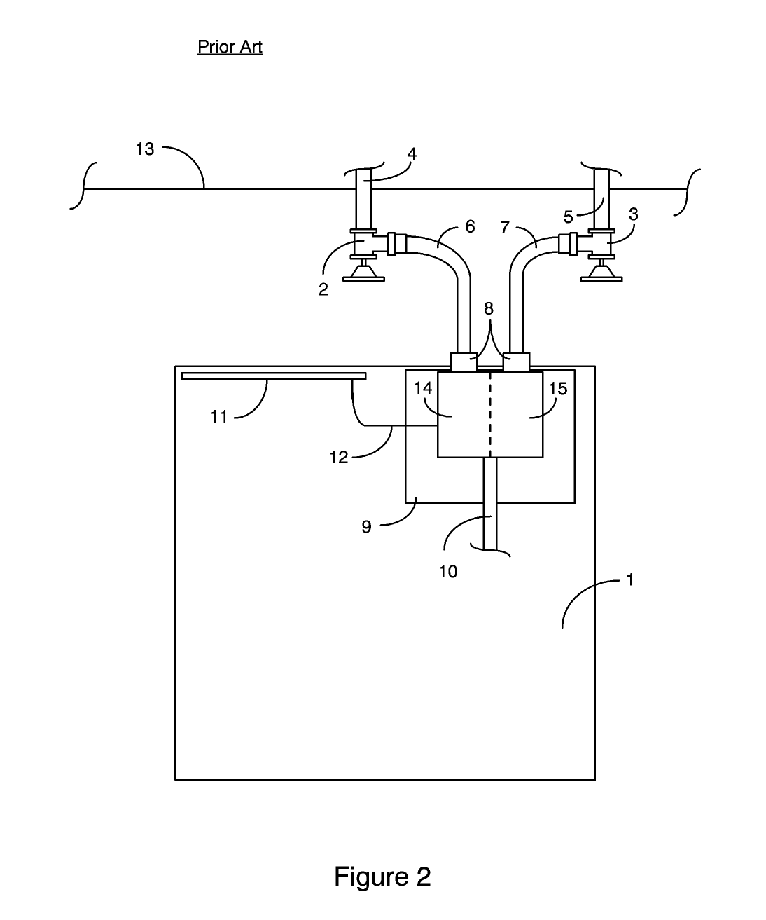

The hot and cold water is supplied to the input solenoid operated water mixing valve assembly 9 through water input fittings 8. The solenoid-operated water mixing valve assembly 9 is electrically connected to the electronic controls 11 via cable 12. When the washing machine 1 is turned on, the electronic controls 11 signals the solenoid operated water mixing valve assembly 9 to selectively open either the hot water solenoid 14 (shown in FIG. 2), the cold water solenoid 15 (shown in FIG. 2), or both. Water is output from the solenoid-operated water mixing valve assembly 9 to fill hose 10 that is used to fill the washing machine 1 with water.

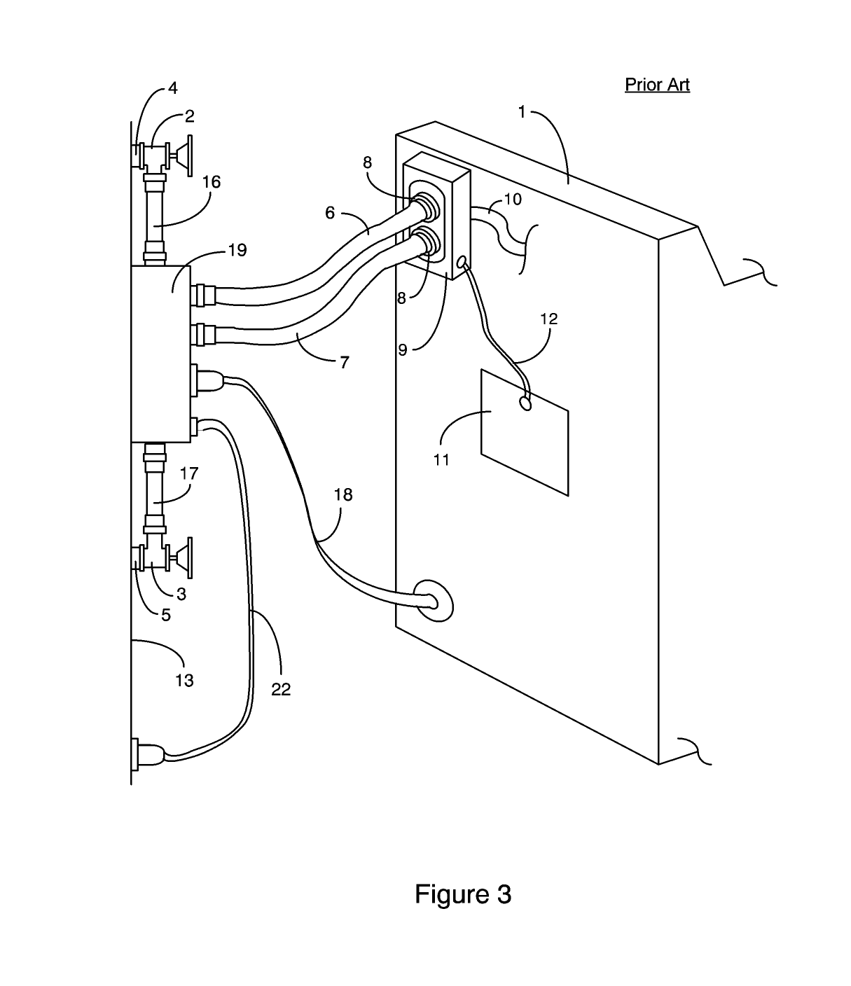

For ease of illustration, power cord 18 (illustrated in the embodiment of FIG. 3) is not shown here or in FIG. 2.

In FIG. 2, a diagram showing the placement of the various components of FIG. 1 is shown. The hot water supply 4 and the cold water supply 5 project from the wall 13. As can be seen from this figure, substantially all of the components are located inside the washing machine 1.

Since the water controls are located inside of the washing machine 1, the flexible water supply hoses 6, 7 are under water pressure at all times. As a result, the constant pressure contributes to fatigue in the flexible water supply hoses 6, 7 that in turn may lead to failure of the flexible water supply hoses 6, 7. When a flexible water supply hose 6 or 7 fails, the water is released in the user's facility at a high rate of discharge. If the user is lucky enough to be present, the damage can be minimized. However, if the user is not present, the water will be discharged unabated until someone observes the damage and takes action to shut off the water. Depending on the location of the water, serious damage may result, including damage to the structural stability of the building. Further, if the leak occurs on an upper floor of a multi-floor building, then third parties may also have their property damaged. Unfortunately, the prior art has not provided a way to economically minimize the risk of damage due to the constant pressure on flexible water supply hoses 6, 7.

Since the water controls are located inside of the washing machine 1, the flexible water supply hoses 6, 7 are under water pressure at all times. As a result, the constant pressure contributes to fatigue in the flexible water supply hoses 6, 7 that in turn may lead to failure of the flexible water supply hoses 6, 7. When a flexible water supply hose 6 or 7 fails, the water is released in the user's facility at a high rate of discharge. If the user is lucky enough to be present, the damage can be minimized. However, if the user is not present, the water will be discharged unabated until someone observes the damage and will takes action to shut off the water. Depending on the location of the water, serious damage may result, including damage to the structural stability of the building. Further, if the leak occurs on an upper floor of a multi-floor building, then third parties may also have their property damaged. Unfortunately, the prior art has not provided a way to economically minimize the risk of damage due to the constant pressure on flexible water supply hoses 6, 7.

The use of multiple flexible water supply hoses 6, 7 also increases the relative risk, since the two flexible water supply hoses 6, 7 used by the prior art present double the potential risk of hose failure that a single flexible water supply hose system would pose.

The fill hose 10 is not under pressure unless the washing machine 1 is actually being used because the solenoid-operated water mixing valve assembly 9 isolates the water supplies from fill hose 10. However, since the solenoid-operated water mixing valve assembly 9 is in the washing machine 1, it is downstream from the last shutoff valves (manual valves 2, 3). As a result, there is a risk of backflow that is not allowed under most building plumbing codes.

FIG. 3 shows a prior art attempt to limit water damage due to hose failure that can be used in conjunction with a conventional washing machine 1. In this figure, the flexible water supply hoses 6, 7 are disconnected from the manual valves 2, 3 and attached to a water control device 19. The water control device 19 is attached to the output of the manual valves 2, 3 via solid pipes 16, 17 respectively. In addition, the power cord 18 is plugged into the water control device 19 whose power cord 22 is plugged into the wall outlet. This type of device is well known in the art and commercially available from the Watts Regulator Company in Andover Mass.

The water control device 19 has a current sensor (not shown) that detects when the washing machine 1 is activated. When the current sensor detects current, it determines that the washing machine 1 is on and it opens two water flow solenoid/valves (not shown) inside the water control device 19. One of the water flow solenoid/valves controls water flow from pipe 16 to hot water flexible hose 6 and the other water flow solenoid controls water flow from pipe 17 to cold water flexible hose 7.

While this device shuts off water flow to the flexible water supply hoses 6, 7, it does so in a disadvantageous manner. First, the water control device 19 requires the use of many components, including two solenoid driven internal valves and the electronic control and current sensing circuitry needed to determine when the water flow should be shut off. This adds cost to the user, both for the cost of the parts and the labor to install them. Second, the this approach does not reduce the number of flexible water supply hoses 6, 7 to one. Therefore, the risk of hose failure is not reduced due to a reduction in the number of hoses. A third disadvantage of this approach is that is fails to reduce the total number of parts required to use the washing machine 1, and, in fact, it actually increases the number of required components.

A fourth disadvantage is that whenever the washing machine 1 is on, the flexible water supply hoses are under water pressure, regardless of whether the washing machine 1 is actually in a fill cycle. Further, if anything is plugged into the water control device 19, other than or in addition to the washing machine 1, the current sensor in the water control device 19 will erroneously determine that the washing machine 1 is in use. The solenoid driven internal valves will then be actuated and water pressure will be applied to the flexible water supply hoses 6, 7. Depending on the type of device plugged onto the outlet, the water control device may permanently apply water pressure to flexible hoses 6, 7. If a multi-outlet electrical plug (such as a power strip) is plugged into the outlet of the water control device 19, the devices using the outlet may defeat the purpose of the water control device 19 entirely.

A fifth disadvantage associated with the water control device 19 is that when the washing machine 1 is turned off, the solenoids in the water control device 19 close. Since the solenoid operated water mixing valve assembly 9 has already closed its valves prior to turning off the washing machine 1, when the valves in the water control device 19 are closed, water is trapped in the flexible water supply hoses 6, 7 under pressure. As a result, the use of a water control device 19 does not reduce hose fatigue since the flexible water supply hoses 6, 7 remain under pressure.

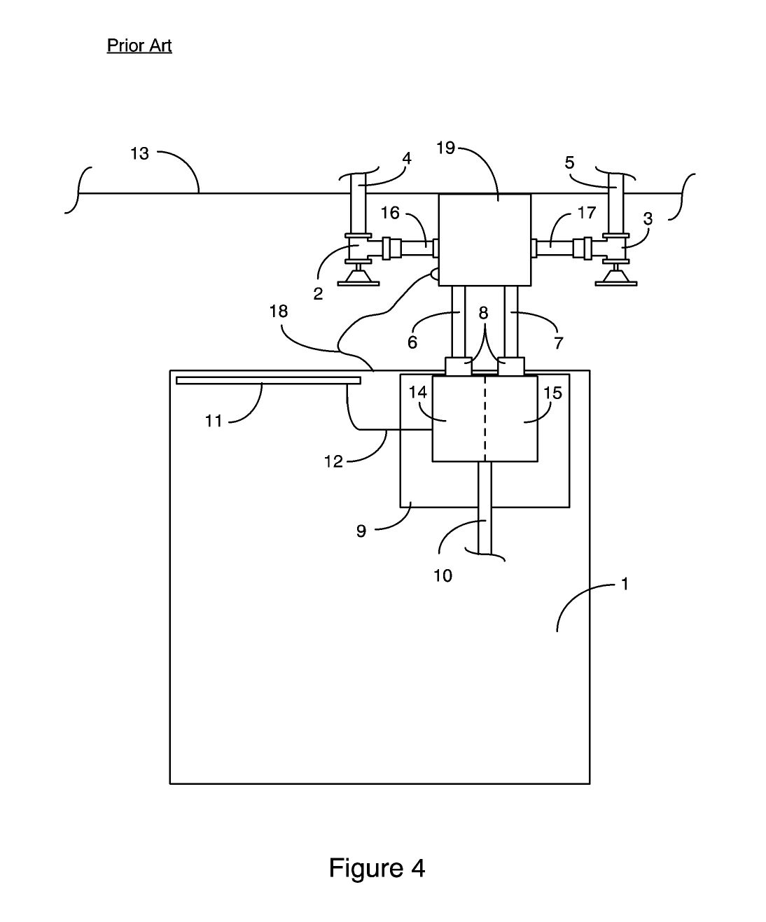

FIG. 4 is a diagram illustrating the location of the components of the prior art embodiment of FIG. 3. As can be seen, all of the equipment in the conventional washing machine 1 remains. In addition, the components inside water control device 19 and the hot and cold water pipes 16, 17 have been added. These additional components all increase cost.

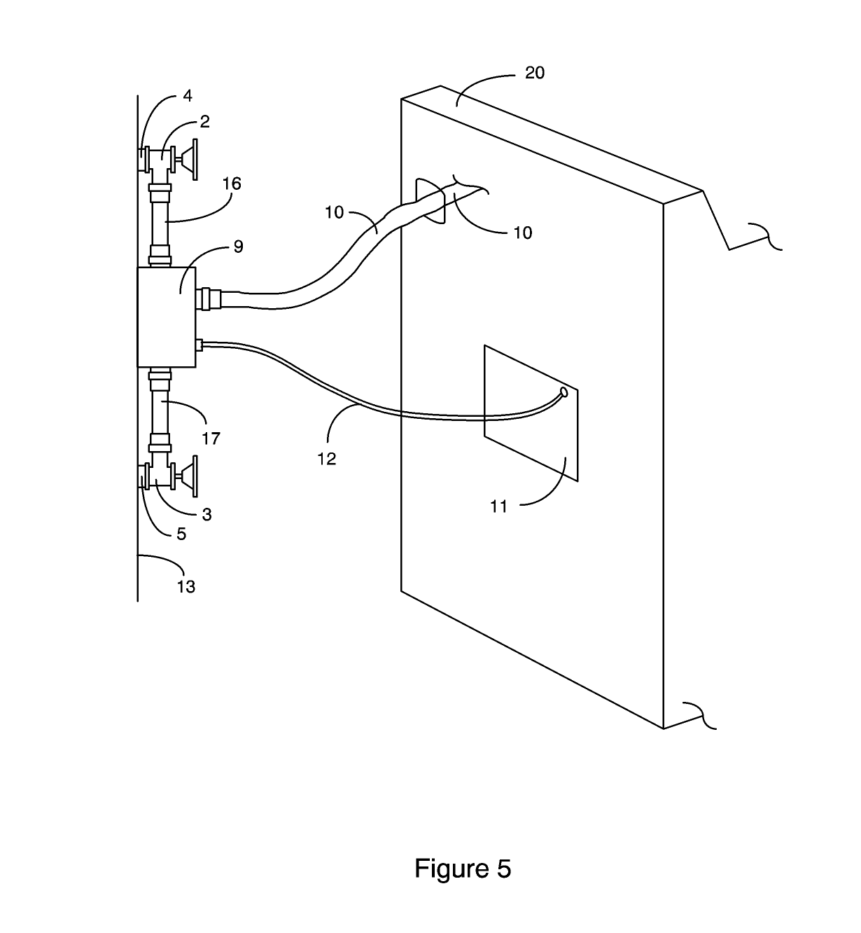

FIG. 5 is a preferred embodiment of the invention with a simplified washing machine 20. As can be seen, the simplified washing machine 20 has been greatly simplified. Only a single flexible fill hose 10 is used to supply both hot and cold water to the simplified washing machine 20. This entirely eliminates both the cost of flexible water supply hoses 6, 7, and the cost of any repairs of damage that a failure of flexible water supply hoses 6, 7 may have caused if they were present.

The solenoid-operated water mixing valve assembly 9 has also been removed from the simplified washing machine 20. The solenoid-operated water mixing valve assembly 9 is preferably installed on the building wall 13 in this embodiment. The outputs of manual valves 2, 3 are directly attached to the inputs of solenoid-operated water mixing valve assembly 9 via solid valve pipes 16, 17. For ease of illustration, valve pipes 16, 17 are shown between manual valves 2, 3 and solenoid operated water mixing valve assembly 9. However, the manual valves 2, 3 can be directly attached to the inputs of solenoid-operated water mixing valve assembly 9.

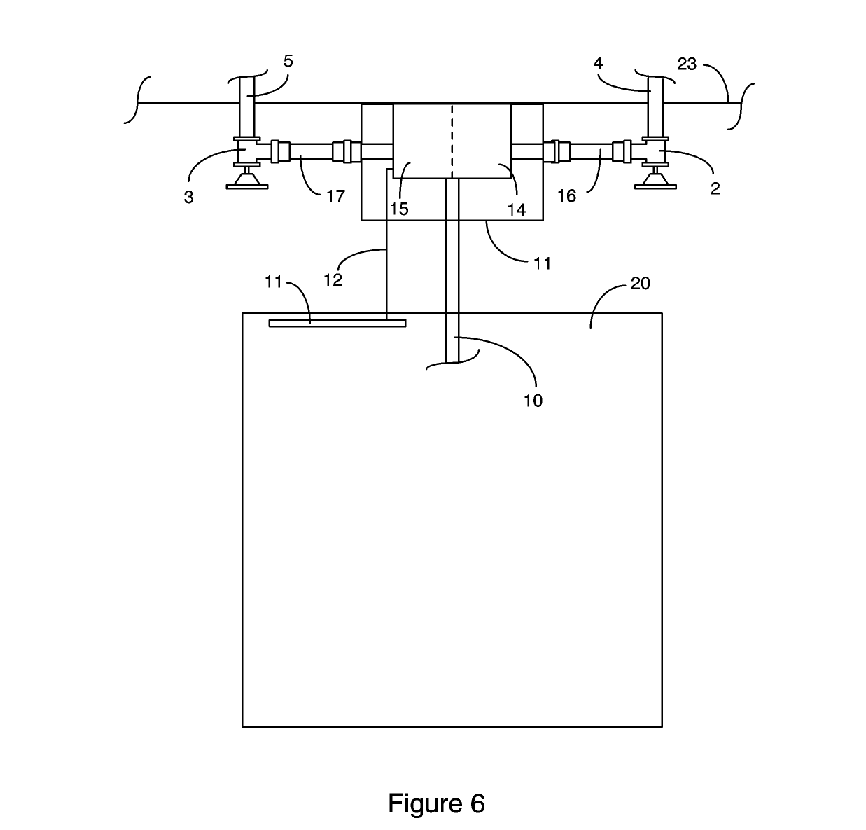

The electronic controls 11 operate in the same manner as it does on conventional prior art washing machines 1. Likewise, the wiring cable 12 operates as it did in the discussion of the prior art figures, above. However, instead of being attached inside the washing machine 1 to an internal solenoid operated water mixing valve assembly 9, it is routed outside of the simplified washing machine 20 to the external solenoid-operated water mixing valve assembly 9. When the washing machine 20 is started, the electronic controls 11 signals the solenoid-operated water mixing valve assembly 9 via wiring cable 12. The solenoid controlled valves 14, 15 (shown in FIG. 6) inside the solenoid-operated water mixing valve assembly 9 are controlled exactly as they were in the prior art.

Several significant advantages are achieved by configuring the components in this manner. First, as a result of removing the solenoid-operated water mixing valve assembly 9 and connecting it directly to the output of the manual valves 2, 3, only the flexible fill hose 10 is required. The water supply hoses 6, 7 are eliminated. This is because the mixing of hot and cold water is done by the solenoid-operated water mixing valve assembly 9 before it is input to the washing machine 20. Of course, this results in a reduced component cost, but more importantly, it results in a washing machine 20 that only uses the flexible fill hose 10, rather than the three hoses (flexible water supply hose 6, flexible water supply hose 7, and flexible fill hose 10) used by the prior art. As a result, two thirds of the flexible water supply hoses available for failure are eliminated, substantially reducing the risk of water damage.

Another important advantage of this configuration is that the flexible water fill hose 10 is not under water pressure unless the simplified washing machine 20 is in the fill cycle. Since water pressure is only applied to flexible water fill hose 10 when the simplified washing machine 20 is being used, the fatigue caused by constant water pressure such as that found in the prior art is eliminated. The reduction of hose fatigue results in longer life for the flexible water fill hose 10 and a reduced risk of failure.

In addition to the immediate savings created by the invention due to the reduction in the total number of parts, the invention also results in future savings. In particular, since the solenoid operated water mixing valve assembly 9 is located outside the simplified washing machine 20, the replacement of the simplified washing machine 20 will be less expensive. Further, if another component of the simplified washing machine 20 causes the simplified washing machine 20 to be replaced, the solenoid-operated water mixing valve assembly 9 will not have to be replaced. Repair costs can also be reduced because of the ease of servicing the solenoid operated water mixing valve assembly 9 since it is outside of the simplified washing machine 20.

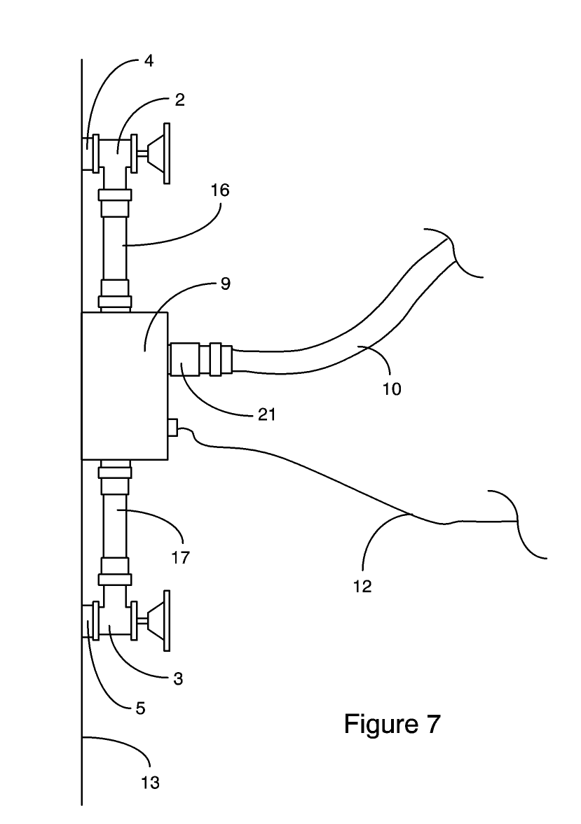

For ease of illustration, power cord 18 (illustrated in the embodiment of FIG. 3) is not shown here or in FIGS. 6-7.

FIG. 6 is a diagram of the simplified washing machine 20 of preferred embodiment of FIG. 5. As can be seen from this view. The number of components in the simplified washing machine 20 has been greatly reduced. The electronic controls 11 signals solenoid controlled valves 14, 15 via wiring cable 12. When the simplified washing machine 20 is activated, the solenoid controlled valves 14, 15 mix the hot and cold water by outputting water to flexible water fill hose 10 in selected proportions.

An additional advantage provided by the invention is that a simplified washing machine 20 can be installed pursuant to local building codes. Heretofore, the flexible water supply hoses 6, 7 that were used by the prior art were in violation of many building codes due to their risk of backflow. By moving the solenoid operated water mixing valve assembly 9 to the wall 13 such that it can be attached directly to the manual valves 2,3, the water supply in the building is no longer subject to leakage problems due to the presence of flexible water supply hoses 6, 7 between the last shutoff valves (i.e.: the solenoid-operated water mixing valve assembly 9 used in the prior art) and the building water supply. The attachment of the solenoid-operated water mixing valve assembly 9 to the building water supply eliminates the presence of flexible hoses 6, 7 between the water supply and a downstream shutoff valve.

FIG. 7 is an illustration of the invention shown in FIGS. 5 and 6 with the addition of a hose connection vacuum breaker backflow connector 21 (hereinafter “vacuum breaker”) connected to the output of the solenoid-operated water mixing valve assembly 9. Vacuum breakers 21 are well known in the art and commercially available from a variety of sources. The advantage of attaching a vacuum breaker 21 to the output of the solenoid-operated water mixing valve assembly 9 is that backflow from the flexible water fill hose 10 is prevented from entering the building water supply. As a result, the configuration used by the invention, allows simplified washing machines 20 to comply with building plumbing codes where heretofore, this was not possible.

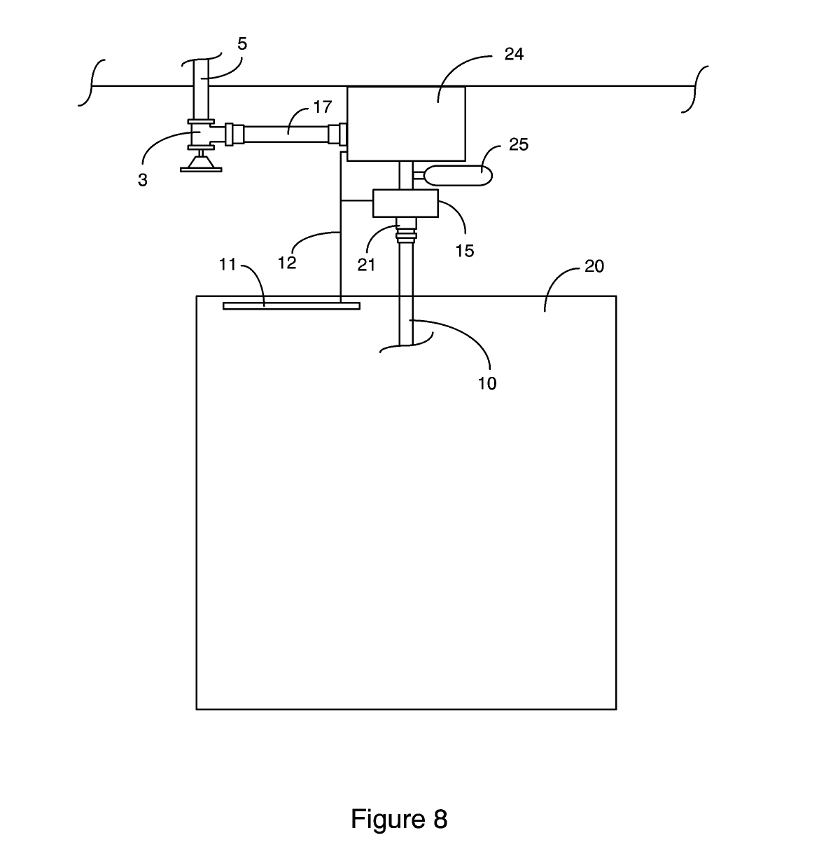

FIG. 8 is a diagram of an alternative preferred embodiment in which cold water line 5 inputs water to a wall mounted water heater 24. For ease of illustration, a power line to the wall-mounted water heater 24 is not shown. The electronic controls 11 provide control information to the wall-mounted water heater 24 via wiring cable 12. The control signals are generated from the operating controls on the front of the clothes washer 20. In addition, the electronic controls 11 also command the solenoid-controlled valve 15, via wiring cable 12, to open when the wall mounted water heater 24 determines that the water is heated to the desired temperature. The wall-mounted water heater 24 heats the water according to the control settings on the clothes washer then provides the heated water to water fill hose 10. As can be seen, the number of components in the simplified washing machine 20 has been greatly reduced. Also shown in this figure is water hammer arrester 25 which is positioned between the wall mounted water heater 24 and the solenoid-controlled valve 15

An additional advantage provided by the invention is that a simplified washing machine 20 can be installed pursuant to local building codes. Heretofore, the flexible water supply hoses 6, 7 that were used by the prior art were in violation of many building codes due to their risk of backflow. By moving the solenoid-controlled valve 15 to the wall 13 such that it can be attached directly to the manual valve 3, the water supply in the building is no longer subject to leakage problems due to the presence of flexible water supply hoses 6, 7 between the last shutoff valves (i.e.: the solenoid-operated water mixing valve assembly 9 used in the prior art) and the building water supply. The attachment of the solenoid-controlled valve 15 to the building water supply eliminates the flexible hoses 6, 7 between the water supply and a downstream shutoff valve.

Also shown in this figure is vacuum breaker 21 which prevents backflow, as discussed above. For ease of illustration, the vacuum breaker 21 and the solenoid-controlled valve 15 are shown as separate elements. However, those skilled in the art will recognize that they can be fabricated as a single integrated unit.

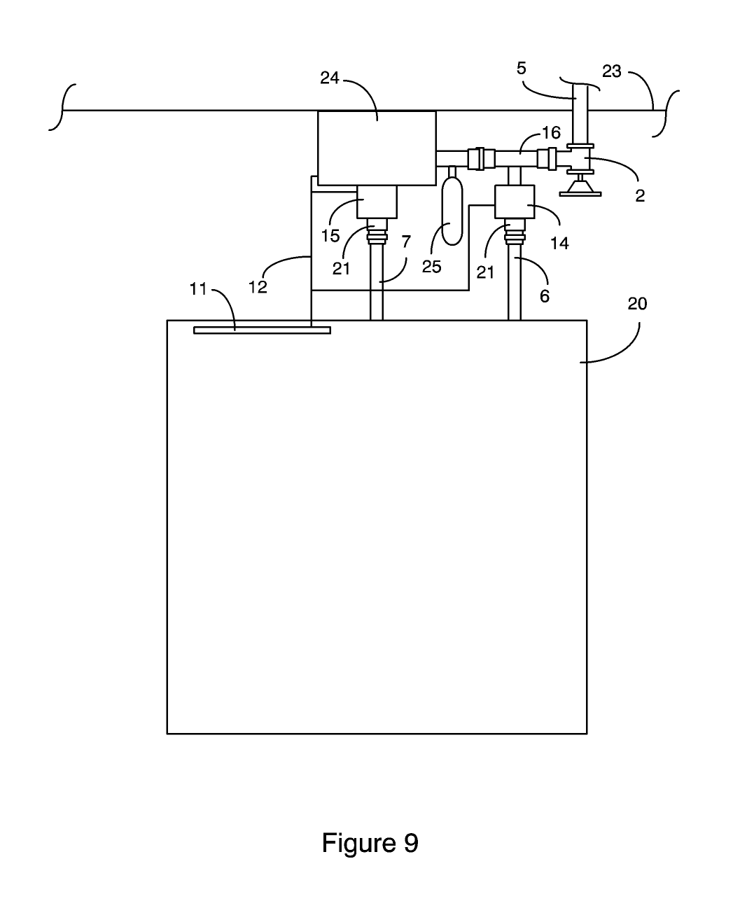

In FIG. 9, another preferred embodiment of the invention is shown. This embodiment also uses a single water supply line 5. In this embodiment, water supply line 5 is split such that some cold water is input to wall mounted water heater 24, and some cold water is fed directly to clothes washer 20. The water heater 24 is controlled by electronic controls 11 and dynamically heats water under thermostatic control on an on-demand basis. This embodiment only requires a single water feed line. As a result, construction costs for providing water to a clothes washer are substantially reduced since twin hot and cold water lines are no longer needed. In this embodiment, the water heater 24 reduces operating costs by only requiring water heating during operation of the clothes washer 20.

Water flow is controlled by solenoid-controlled valves 14, 15, each of which has a vacuum breaker 21. The vacuum breakers 21 can be stand alone units, or integrated with the solenoid-controlled valves 14, 15.

The invention has been described herein as applying to clothes washers. However, any equipment that uses both a hot and cold water supply fed by flexible hosing can benefit from the invention. Further, the invention can be used with devices that use liquids other than water, as well as machines the require only a single water input due to the absence of a need for water of a varying temperature. Likewise, the electronic controls can be implemented by other methods such as mechanical devices.

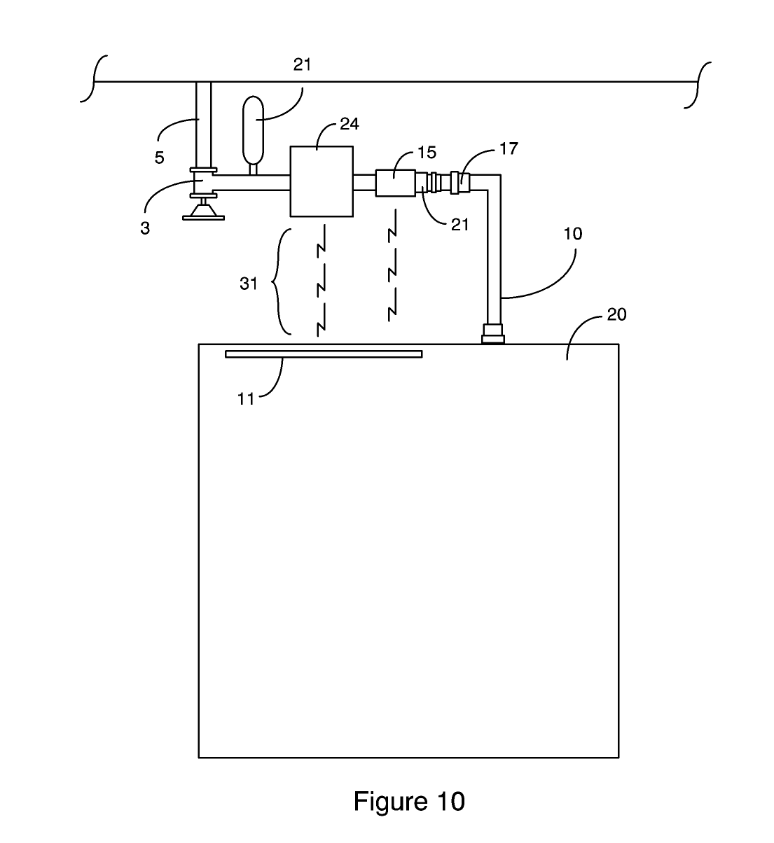

FIG. 10 is a plan view of yet another preferred embodiment in which a single cold feed line 5 inputs water to a water heater 24 that dynamically heats water under thermostatic control on an on-demand basis. This embodiment differs from the embodiment of FIG. 8 in that the water heater 24 and solenoid-controlled valves 15 are wirelessly controlled by signals 31 from the control circuits 11 in the clothes washer 20. This embodiment has the advantage of providing the simplest configuration.

Water fill hose 10 is also shown. As is the case with the other embodiments, water fill hose 10 will never have water in it unless the clothes washer is being filled during normal operation. As a result, the risk of damage due to flooding from a burst hose while the owner is away is eliminated.

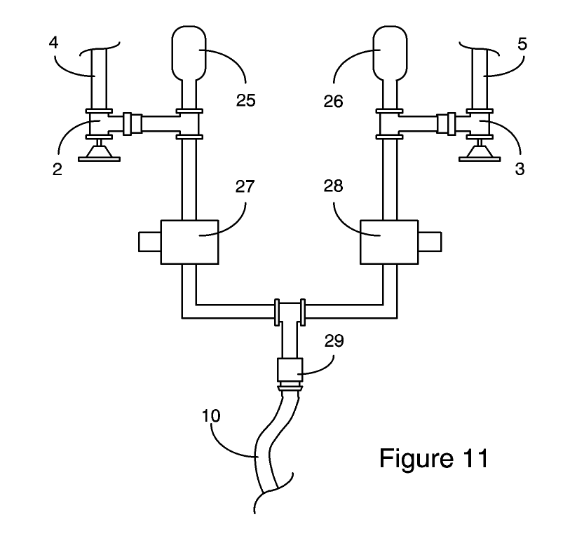

FIG. 11 is another preferred embodiment in which solenoid valves 27, 28 are placed between the hot and cold water supplies 4, 5 respectively. The solenoid valves 27, 28 are electronically controlled by the clothes washer to produce a selectable mixture of hot and/or cold water to produce a desired water temperature. The water mixture is output through vacuum breaker 30 to hose 10 which delivers water to the washing machine. An advantage of this embodiment is that it allows a single fill hose to deliver water at a selected temperature to the clothes washer. Further, since the solenoids are positions on the input of hose 10, there is no water pressure on hose 10 unless the clothes washer is being filled for use. This eliminates the possibility of accidental flooding caused by a rupture or leak in hose 10.

Also illustrated in this figure are water hammer arresters 25, 26. Water hammer arresters 25, 26 eliminate problems caused by pressure variances when the solenoid valves 27, 28 are activated. Manual shutoff valves 2, 3 are also illustrated.

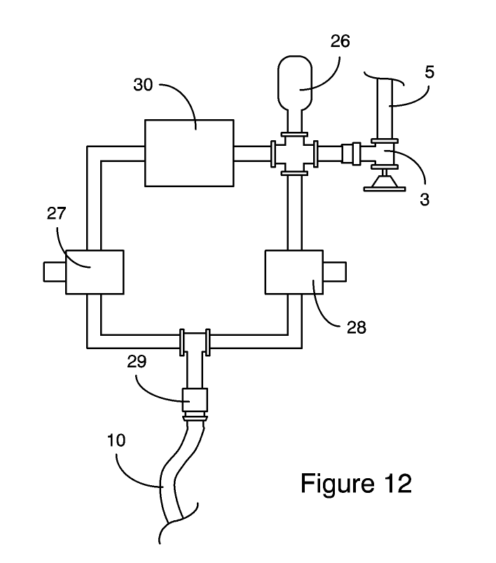

FIG. 12 is yet another preferred embodiment in which a single cold water supply 5 feeds cold water to a cold water solenoid valve 268 and also feeds cold water to a tankless water heater 30 that in turn feeds hot water to a hot water solenoid valve 27. The hot and cold water is output to a washing machine via a single fill hose 10. Vacuum arrester 26 is shown along with shutoff valve 3. This embodiment is more fuel efficient in that water is only heated when needed. In addition, only a single water supply line 3, a single shutoff valve 3 and a single water hammer arrester 26 are needed.

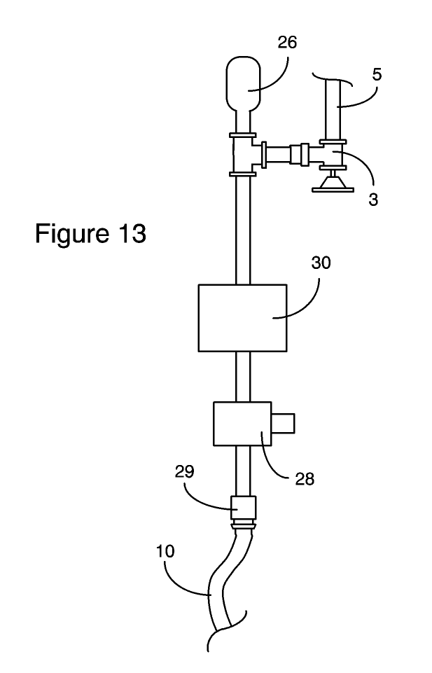

FIG. 13 is another preferred embodiment in which a single cold water supply 5 feeds cold water to an adjustable temperature tankless water heater 30 that in turn feeds water to a water solenoid valve 28. The water is output to a washing machine via a single fill hose 10. The advantages of this embodiment are that 1) only a single cold water supply line is needed, 2) energy use is reduced because water is only heated when needed, and 3) this embodiment provides a greatly simplified structure with a minimal number of parts.

Throughout the specification, the invention has been illustrated and discussed using hard wiring between the clothes washer and the wall mounted water heater and the solenoid-controlled valves. However, those skilled in the art will recognize that the invention can also be implemented using a wireless technology, such as Bluetooth. The use of a wireless technology allows a clothes washer to be installed with greater ease and results in a simpler and cleaner appearance.

While the invention has been described with respect to a preferred embodiment thereof, it will be understood by those skilled in the art that various changes in detail may be made therein without departing from the spirit, scope, and teaching of the invention. For example, the solenoid-operated water mixing valve assembly 9 can be attached to the wall 13 or supported by the manual valves 2, 3. The type of material used to fabricate the flexible water fill hose 10 can vary. The purpose of the machine, whether for washing dishes, clothing, or for another purpose that uses dual water supplies, can vary. Accordingly, the invention herein disclosed is to be limited only as specified in the following claims.

I claim:

1. An apparatus for mixing hot and cold water to a washing machine using a single water supply hose, comprising:
a washing machine, the washing machine further comprising:
a water fill hose attached to the washing machine at its proximal end; and
an electrical signal cable connected at a first end to the output of the electronic controls;
an externally located solenoid operated water mixing valve assembly, further comprising:
means to attach to the electrical signal cable;
a cold water input;
a first solenoid operated valve for controlling the amount of cold water input from the cold water input, the operation of the first solenoid operated valve controlled by signals on the electrical signal cable;
a hot water input;
a second solenoid operated valve for controlling the amount of hot water input from the hot water input, the operation of the second solenoid operated valve controlled by signals on the electrical signal cable;
means to mix the hot and cold water output by the first and second solenoid operated valves; and
a water output having means to attach to the distal end of the water fill hose, the mixed hot and cold water output from the solenoid operated water mixing valve assembly to the water fill hose;
whereby hot and cold water is mixed prior to input to a washing machine by single water fill hose.

2. An apparatus, as in claim 1, wherein the washing machine is a clothes washer.

3. An apparatus, as in claim 1, wherein:
the washing machine has means to determine when a fill cycle begins and ends; and
the washing machine signals the first and second solenoid operated valves to open when the fill cycle begins and the washing machine signals the first and second solenoid operated valves to close when the fill cycle.

4. An apparatus, as in claim 3, wherein the washing machine is a clothes washer.

5. An apparatus, as in claim 3, further comprising:
a vacuum breaker, the vacuum breaker attached to the output of the solenoid operated water mixing valve assembly, and the distal end of the water fill hose is attached to the vacuum breaker;
whereby the vacuum breaker prevents backflow of water.

6. An apparatus, as in claim 1, further comprising a vacuum breaker, the vacuum breaker attached to the output of the solenoid operated water mixing valve assembly, and the distal end of the water fill hose attached to the vacuum breaker;
whereby the vacuum breaker prevents backflow of water.

7. An apparatus, as in claim 6, wherein the washing machine is a clothes washer.

8. A method of supplying hot and cold water to a washing machine with a single water supply hose, including the steps of:
attaching a water fill hose to a washing machine at its proximal end;
externally locating a solenoid operated water mixing valve assembly from the washing machine;
attaching the water fill hose to the solenoid operated water mixing valve assembly at its distal end;
inputting cold water to the solenoid operated water mixing valve assembly;
inputting hot water to the solenoid operated water mixing valve assembly; and
signaling the solenoid operated water mixing valve assembly, under control of the washing machine, to output water to the water fill hose;
whereby hot and cold water is mixed prior to input to a washing machine by single water fill hose.

9. A method, as in claim 8, including the additional step of using a clothes washer as the washing machine.

10. A method, as in claim 8, including the additional steps of:
determining when a fill cycle begins and ends; and
signaling the first and second solenoid operated valves to open when the fill cycle begins and signaling the first and second solenoid operated valves to close when the fill cycle ends.

11. A method, as in claim 10, including the additional step of using a clothes washer as the washing machine.

12. A method, as in claim 10, including the additional steps of:
attaching a vacuum breaker to the output of the solenoid operated water mixing valve assembly; and
attaching the distal end of the water fill hose to the vacuum breaker;
whereby the vacuum breaker prevents backflow of water.

13. A method, as in claim 8, including the additional steps of:
attaching a vacuum breaker to the output of the solenoid operated water mixing valve assembly; and
attaching the distal end of the water fill hose to the vacuum breaker;
whereby the vacuum breaker prevents backflow of water.

14. A method, as in claim 13, including the additional step of using a clothes washer as the washing machine.
